(19) United States
(12) Patent Application Publication
(10) Pub. No.: US 2003/0233282 A1
(43) Pub. Date: Dec. 18, 2003

(54) Process for automatically ordering permanent versions of individual songs or albums heard on satellite or digital radio stations

(76) Inventors: Christopher Thomas Ward, Atlanta, GA (US); Peter Scott Curtiss, Boulder, CO (US)

Correspondence Address: Christopher Thomas Ward, 4113 Peachtree Dunwoody Rd., Atlanta, GA, 30342, US

(21) Appl. No.: 10/171,372

(22) Filed: Jun. 12, 2002

(51) Int. Cl. G06F 17/60

(52) U.S. Cl. 705/26

(57) ABSTRACT

This patent covers a process for automatically ordering permanent versions of individual songs or albums heard on satellite or digital radio stations. As the song is being played, existing RDS or other song/artist identification techniques are used to identify the recording label, artist, album and song. By pressing a button on the front of the radio, the listener can send a signal to a processing center and order the album or CD, or they may also purchase just the compressed version of the song suitable for playback using standard MP3 or equivalent technologies. The payment transaction occurs either through the radio subscription service or through a third-party service. A menu that appears during the purchasing process is used to select purchase of either the single song, the entire album or CD, and is also used to confirm the purchase.

### CROSS REFERENCE TO RELATED APPLICATIONS

This application builds on existing satellite and digital radio broadcasting systems that incorporate information related to the current broadcast musical or vocal program.

It is similar to the embodiments in U.S. Pat. No. 6,246,672 that considers an interactive radio system with voice recognition of various functions. However, said patent does not include the capability to issue purchase requests for musical or talk programs heard on the radio.

It is also similar to the U.S. Patent application 20020048224 which allows the radio listener to download textual title and track information about received music. Again, however, said patent does not provide for the necessary two-way communication discussed in this application for the express purchase of permanent version of individual songs or CDs. U.S. Patent application 20010042109 seeks to improve upon the technology described in application 20020048224 by removing the need for a personal computer system to provide an interface analogous to a radio receiver, but again the presence of a selection and purchage mechanism does not exist.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of communications and more specifically to a process for automatically ordering permanent versions of individual songs or albums heard on satellite or digital radio stations.

Technology advances over the past couple of decades have seen remarkable changes in how people listen to music. As music moves into the digital age, there are a number of ways to transfer and store the music and associated information. In addition, there are a number of ways to reproduce this music depending on the desired sound quality and limitations on the size of the digital files containing the encoded music.

With the advent of the MP3/MP4 encoding standard, it is now common for people to carry around substantial personalized libraries of music. However, the retrieval of this music is subject to a number of impediments, such as internet-based download services that may be quite slow and do not have songs of the desired sound quality.

Often, when people hear a song on the radio they like, it is difficult to find out who the artist is and what album the song is from unless the DJ immediately announces this information. There is also the widespread problem of finding the proper music album or CD only to discover that the other songs on that album or CD are not interesting. At that point, the consumer can end up paying the full cost of the CD for only one or two songs that they would like to hear again.

Two recent advances in radio transmission, however, may help streamline the music selection and purchasing problems. RDS radio systems allow for the encoding of certain information into the radio signal itself. While this is currently used primarily for station call letter and format identification, there is the potential to have extra bandwidth used for artist, album, and song identification. With the proper RDS decoding equipment, it is possible to extract the salient information from the encoded signal. Likewise, the advent of satellite-based digital broadcasting systems (notably XMRadio) also allows for song-specific information to accompany each track played on the radio.

It is desirable to have a system whereby the existing encoded information in radio signals is used to identify an exact artist, album, and track and then the information is used to purchase a single song or an entire album/CD for playback whenever the consumer desires. By providing the song/audio program in digital format, the consumer could retrieve the purchased track or CD from the Internet and store it on whatever portable playback device is convenient.

The method described in this patent is based on the successful implementation of two other essential technologies: the available bandwidth in RDS signals for storing information about a piece of music played on the radio, and the ability of wireless communications (e.g., cell phones and PDAs) to perform transactions on the Internet. The method is a innovative combination of these two technologies, allowing people to identify and purchase music as soon as it is heard. Currently, the only way to do this is to identify a song through either waiting for the radio announcer or to track down the station's play list. Both of these methods are time consuming and not always successful. By automating the process the purchase of music will be made much easier.

### BRIEF SUMMARY OF THE INVENTION

The primary object of the invention is to provide radio listeners with a method for identifying and purchasing desired music rapidly and at the impulse of the listerner.

Another object of the invention is to allow music companies to promote their products and allow for impulse sales even when the listener is not in a music store.

Another object of the invention is to provide value-added features to satellite and digital radio sets now being offered.

A further object of the invention is to promote business collaboration between radio manufacturers and cellular/wireless service providers.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for automatically ordering permanent versions of individual songs or albums heard on satellite or digital radio stations comprising the steps of: a hardware/software mechanism that allows a song to be quickly and uniquely identified, a radio with built-in wireless transmitter, a radio with a button used to send purchasing requests to central processing center via wireless communications, and a confirmation algorithm that verifies that the purchase was intended.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows the flow of information from the radio station to the radio and subsequently to the processing center.

FIG. 2 is an elevational view of the radio.

FIG. 3 is a flow chart of the process.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Preferred embodiments of the present invention will not be described with reference to the accompanying drawings.

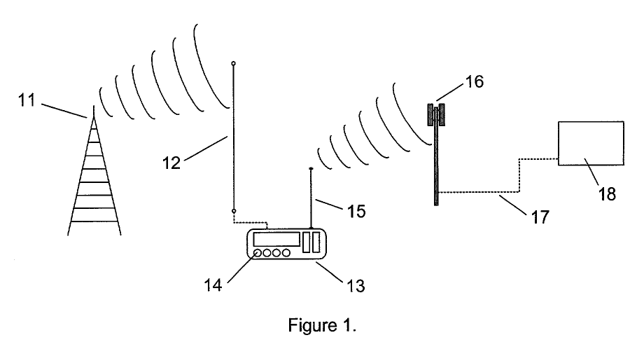

In accordance with the present invention, FIG. 1 shows an overall strategy for information transfer from the radio station (11) to the radio antenna (12). The antenna captures the signal like a normal radio, but the attached signals are then interpreted by the radio (13) to provide both audible signals as well as the unique identification of the song, artist and album currently being played.

If the user wishes to purchase the song currently being played, the user may press the purchase button (14) which then sends the appropriate signals out through the wireless communication antenna (15) to a standard cell phone or other wireless communications antenna (16). The information is then passed through ground-based or similar infrastructure (17) to the central processing center (18) that processes the music order. The processing involves either electronic shipping of an MP3/MP4 file to the user's electronic mail account or a physical shipment of the music CD to the user's specified address.

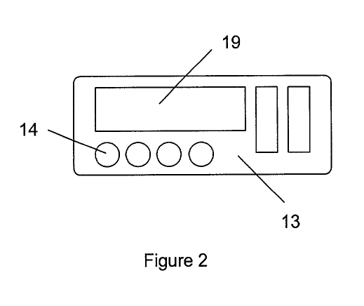

In accordance with the present invention, FIG. 2 shows a view of the front panel of the radio (13). The purchase button (14) is used to initiate the request process and causes certain information to be displayed on the screen (19). This information gives the user the option of purchasing a single track or entire CD. The user will also use this screen to identify any problems with the purchase, such as incomplete song identification data or the radio being out of wireless range with the processing center.

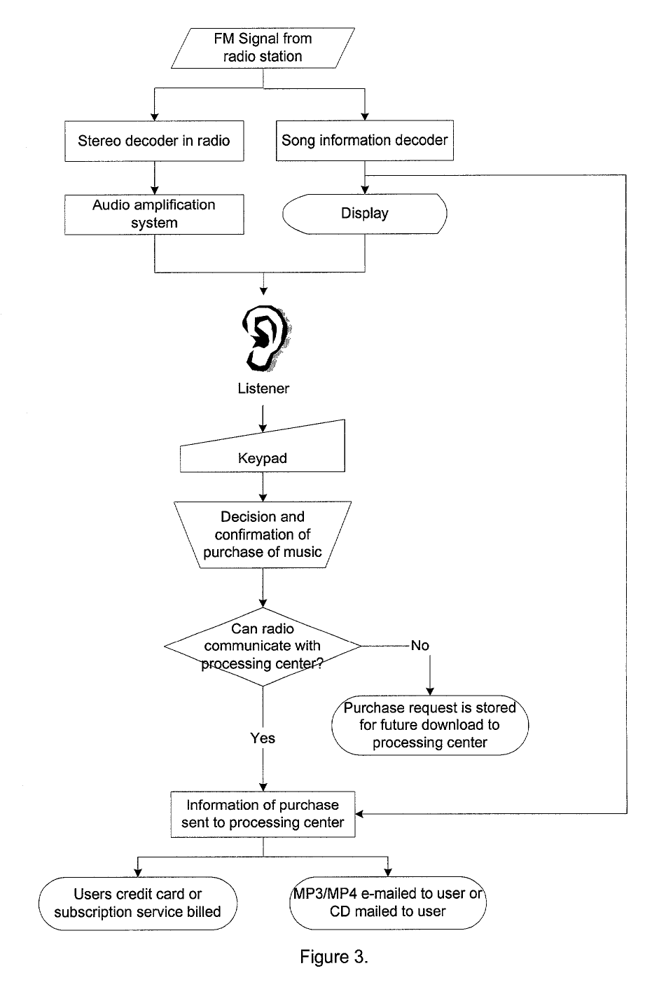

In accordance with the present invention, FIG. 3 shows a flow chart of the data flow in this process:

The communications with the service center shall be encoded with the standard security measures similar to those used for other wireless financial transactions.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for automatically ordering permanent versions of individual songs or albums heard on satellite or digital radio stations comprising the steps of:
a hardware/software mechanism that allows a song to be quickly and uniquely identified
a radio with built-in wireless transmitter;
a radio with a button used to send purchasing requests to central processing center via wireless communications; and
a confirmation algorithm that verifies that the purchase was intended.
